(19) United States
(12) Patent Application Publication
(10) Pub. No.: US 2026/0245326 A1
(43) Pub. Date: Aug. 20, 2026

(54) VEHICLE OCCUPANT DETECTION DEVICE AND VEHICLE

(71) Applicant: MERCEDES-BENZ GROUP AG, Stuttgart (DE)

(72) Inventors: Emin TARAYAN, Sindelfingen (DE); Volker DOHMEYER, Calw (DE); Jochen SENDLER, Stuttgart (DE)

(21) Appl. No.: 19/164,817

(22) PCT Filed: Feb. 27, 2024
(86) PCT No.: PCT/EP2024/055016

§ 371 Date: Sep. 12, 2025

(30) Foreign Application Priority Data
Mar. 13, 2023 (DE) 10 2023 000 955.5

(51) Int. Cl. G06V 10/141; B60K 35/22; B60Q 3/76; B60R 21/015; G06T 7/73; G06V 20/59; G06V 40/20; H04N 23/20

(52) U.S. Cl. CPC G06V 10/141; B60K 35/22; B60Q 3/76; B60R 21/01538; B60R 21/01552; G06T 7/74; G06V 20/593; G06V 40/28; H04N 23/20; G06T 2207/10048; G06T 2207/10152; G06T 2207/30201; G06T 2207/30268

(57) ABSTRACT

A vehicle occupant detection device includes an infrared light source, a camera, and a computing unit controlling the infrared light source and evaluating camera images generated by the camera. The infrared light source and the camera are aligned with an observation area. The infrared light source illuminates at least one face area of a person in the observation region, the camera detects at least the illuminated face area, and the computing unit recognizes a line of sight of the person in the camera images. The infrared light source is integrated into a display device and formed by a plurality of IR light elements arranged in a matrix. The computing unit activates a selection of the IR light elements for emitting infrared light. The computing unit determines the selection of the IR light elements to be activated depending on the evaluation result of a camera image.

### BACKGROUND AND SUMMARY OF THE INVENTION

Exemplary embodiments of the invention relate to a vehicle occupant detection device, as well as to a vehicle with such a vehicle occupant detection device.

Modern vehicles have a wide variety of sensor systems for detecting the vehicle surroundings and the vehicle interior. This enables the provision of various driver assistance systems to increase user comfort and improve road safety. Detection of a vehicle driver using cameras is well-known. This allows gestures to be recognized and interpreted to input operation actions, to determine the presence of a vehicle occupant, to identify a vehicle occupant based on biometric characteristics, or to determine the attention level, state of health and/or level of distraction of the vehicle driver.

Camera-based observation of the driver's eyes is particularly important. The frequency of blinking, for example, can be an indicator of the driver's level of fatigue. In addition, the line of sight of the driver can be tracked, for example to determine the level of distraction or to check what the driver is currently focusing on. This requires accurate and reliable monitoring of the driver's eyes. To be able to recognize the eyes clearly even in poor visibility conditions, such as at night, infrared cameras are often used, particularly in combination with active infrared lighting. In addition, filters such as bandpass filters can be provided, which only allow infrared light to pass through. Such a filter can be integrated into the lens of a corresponding camera or can also be digitally embodied. This allows, for example, disturbing glare effects resulting from ambient light to be reduced or filtered out in such a way that only relevant infrared light wavelengths are allowed to pass through.

However, when infrared light sources are used, reflections in the infrared light spectrum may also occur, for example on glasses worn by the driver. Infrared light from the vehicle surroundings can also penetrate the vehicle interior and cause a dazzling effect. This can also cause shadows to be cast. Relevant areas of the camera image can then be overexposed or underexposed in the infrared light spectrum in such a way that reliable detection of the vehicle driver's eyes is compromised.

DE 10 2017 205 386 A1 discloses a driver observation device and a method for observing a driver in a vehicle to determine at least one position of the driver in the vehicle. The driver observation device provides double-sided illumination of the driver with light. This illuminates the driver from both the rear and front, wherein infrared light is used in particular. Using appropriate light sources, a structured light pattern such as a line grid can also be projected onto the driver. This enables reliable positioning of the driver's head using active triangulation. The camera used to detect the driver's face can be simultaneously used to detect the line of sight.

In addition, DE 10 2017 216 680 A1 discloses a vehicle cockpit element and a motor vehicle with such a vehicle cockpit element. The publication describes an infrared light source formed as a surface light source for illuminating the face of a driver. The surface light source is formed, for example, by an OLED film and can be integrated into the vehicle's steering wheel. A flat embodiment of the infrared light source has the advantage over a point light source that shadows on the driver's face are reduced or even eliminated due to the diffuse light emission. This enables more reliable detection of the driver's face. However, this cannot prevent reflections from occurring. In addition, the installation space in the vehicle for accommodating a corresponding vehicle cockpit element is limited, which means that the vehicle cockpit element can only be integrated into a corresponding vehicle with a considerable amount of work.

WO 2019/215286 A1 further discloses a device and a method for operating an object recognition system for the interior of a motor vehicle, as well as a motor vehicle. The device uses an infrared light source integrated into a display device of the motor vehicle to illuminate the face area of a vehicle occupant with infrared light. The infrared light source comprises a plurality of IR light elements arranged in a matrix. The IR light elements can be controlled based on an evaluation of a camera image showing the illuminated face area.

DE 10 2014 009 143 B4 further discloses a motor vehicle camera device with controllable active lighting. An optical filter, which has at least two different filter areas that differ in their transparency at least temporarily, is arranged in the beam path of a light source of the active lighting. The transparency can be specifically increased or decreased to avoid light reflections in camera images generated by the camera device.

In addition, U.S. Pat. No. 9,290,146 B2 discloses optical monitoring of a vehicle interior. This can be used to deploy a vehicle's airbag only if a person is also actually sitting in a seat assigned to the respective airbag.

Exemplary embodiments of the present invention are directed to an improved vehicle occupant detection device enabling even more reliable detection of the eyes of a vehicle driver. The vehicle occupant detection device should be easy to integrate into a vehicle.

A generic vehicle occupant detection device comprising at least one infrared light source, a camera, and a computing unit for controlling the infrared light source and for evaluating camera images generated by the camera, wherein the infrared light source and the camera are aligned with an observation region, the infrared light source is configured to illuminate at least one face area of a person in the observation region, the camera is configured to detect at least the illuminated face area, and the computing unit is configured to recognize a line of sight of the person in the camera images. The infrared light source is integrated into a display device and is formed by a plurality of IR light elements arranged in a matrix, and the computing unit is further configured to activate a selection of the IR light elements for emitting infrared light. The computing unit determines the selection of the IR light elements to be activated depending on the evaluation result of a camera image. The computing unit is further configured to control the matrix of IR light elements to emit a structured light pattern and to determine the relative position between the pupil of the person and at least one portion of the light pattern in order to determine the line of sight of the person in a camera image.

With the help of the vehicle occupant detection device according to the invention, it is possible to detect an observed person even more reliably, in particular the eye area. The infrared light source comprises a plurality of individually controllable IR light elements. These are arranged in the form of a matrix in such a way that each IR light element emits infrared light primarily into a specific region of space. By selectively switching the IR light elements on and off, infrared light can be specifically directed into different areas of space. This is used to increase the illumination of areas of space that need to be brightened by infrared light and, accordingly, to not illuminate areas of space that should not be illuminated. This enables more even illumination of a scene with infrared light in such a way that camera images can be produced that contain fewer overexposed or underexposed areas.

To determine how the IR light elements are to be activated, initially a camera image of the scene is captured. The infrared light source can be deactivated or activated while this camera image is being captured. If the infrared light source is deactivated, the influence of infrared light cast from the surroundings into the captured scene can be determined. If, on the other hand, the infrared light source is activated, for example, in this case, all IR light elements of the matrix can be activated, the influence of the infrared light source itself on the illumination of the scene can be detected. Multiple camera images can also be evaluated in stages, wherein individual combinations of IR light elements are activated when each of the different camera images are captured. If there are objects within the observation area that reflect infrared light, such as glasses worn by a person, a correspondingly overexposed area will appear in the corresponding camera image. The computing unit controls the infrared light source after that to deactivate IR light elements in a specific manner in such a way that no reflections occur. Furthermore, IR light elements can be activated in a specific manner to direct more infrared light into areas of the image that are too dark.

For example, the computing unit evaluates the camera image captured in this way based on specific predefined criteria. For example, different performance indicators, also known as key performance indicators (KPIs), can be specified, based on which the camera image is evaluated. For this purpose, for example, the signal-to-noise ratio, the saturation of a specific color channel or similar can be evaluated for the entire camera image or different camera image areas. Depending on which characteristic takes on which performance indicator in which image region, the lighting setup is changed via a controller in such a way that other IR light elements are activated.

The vehicle occupant detection device according to the invention can also be integrated particularly easily into vehicles. The matrix of IR light elements is thus part of a display device, an element that is already installed multiple times in the cockpit of modern vehicles, for example to display information to be output via an instrument cluster. The matrix of IR light elements is therefore not directly visible to the observer, which improves the visual appearance of the vehicle occupant detection device. This enables aesthetic and concealed integration of at least the infrared light source.

The IR light elements can be embodied in various ways. The IR light elements can, for example, be embodied in the shape of points, such as pixels or subpixels. At least some of the IR light elements can also be embodied as flat or planar light elements, for example as a light strip or light square. Accordingly, several such surfaces or strips can be arranged next to one another to form the matrix. Point-shaped and flat light elements can also be combined.

The IR light elements can be operated continuously or also pulsed while the camera images are being captured. In pulsed mode, the camera and the infrared light source are synchronized with one another in such a way that infrared light is emitted exactly when a camera image is generated. This enables videos to be reliably recorded in the dark.

The infrared light output emitted to illuminate the scene, i.e., the observation area, remains almost constant compared to the use of a single point light source. However, since the total output is distributed over a larger area, the area-related infrared light output is reduced, whereby the radiation exposure for the person is reduced and eye safety is improved. This also has the effect of achieving a more even heat distribution.

As described, the computing unit is further configured to control the matrix of IR light elements to emit a structured light pattern and to determine the relative position between the person's pupil and at least one portion of the light pattern in order to determine the person's line of sight in a camera image. This allows the person's line of sight to be determined even more accurately. The light pattern generated by the infrared light source is projected onto the cornea of the person being observed. Compared to a point light source, there are thus more IR structures on the cornea, which allows more accurate determination of the position of the pupil relative to the light pattern. This also allows more accurate determination of the relative position and thus the line of sight.

In conventional methods for detecting the line of sight, the distance of the pupil to the corneal reflection on the cornea is measured. The location of the corneal reflection on the cornea is independent of the line of sight. However, if the person being observed moves, the angle of incidence of the infrared light on the eye may change in such a way that the corneal reflection also shifts. By using a structured light pattern instead of a point light source, however, the head movements made by the person being observed can be tracked in such a way that their influence on the line of sight can be filtered out. For example, if the person being observed moves towards the infrared light source, the structured light pattern becomes larger. If, on the other hand, they move up, down, left or right in the plane, different portions of the eyeball are illuminated in such a way that some areas of the structured light pattern become larger and others smaller. Depending on which areas of the structured light pattern change in size and how significant the change is, the computing unit is able to detect a change in head position and take this into account accordingly when calculating the line of sight.

All conceivable shapes and geometries can be used as light patterns, such as straight or curved lines, diamond grids, cross grids, or even dot patterns and similar.

In an advantageous development of the vehicle occupant detection device provision is made that, in a display device designed as an LCD display, the matrix of IR light elements is integrated into the background lighting of the display device or at least forms part of it, and in a display device designed as an OLED display, the matrix of IR light elements corresponds to a matrix of pixels in such a way that each IR light element forms an additional subpixel of a pixel. The infrared light source formed as a matrix of IR light elements can thus be integrated into display devices of different technologies. Since the crystals of an LCD display are usually transparent to infrared light, the IR light elements can be integrated into an LCD display in a particularly simple and cost-effective manner in that the IR light elements are integrated into the background lighting or in that they form at least part of it. The LCD display can be embodied as a monochrome display or as a color display. To enable a viewer to see the display content on the LCD display even in adverse lighting conditions, the display is illuminated by the background lighting. Thus, light elements that emit white light, for example, continue to be part of the background lighting. The IR light elements can then be integrated into the LCD display in addition to these already existing light elements.

A particularly energy-efficient embodiment of the vehicle occupant detection device is possible when using OLED displays. Such an OLED display comprises a plurality of pixels, which are also arranged in a matrix. The pixels in turn comprise subpixels from organic light-emitting diodes of different colors, for example red, green and blue and/or cyan, magenta, and yellow. According to the invention, an additional subpixel emitting infrared light is then integrated for at least a portion of the pixels of the OLED display. Compared to the LCD display, the light-emitting elements are then arranged comparatively far forward in the viewing direction of the OLED display in such a way that light can be projected into the surroundings with high efficiency and intensity. This means that the light does not have to pass through deeper display layers, whereby the light intensity could be attenuated.

Different display technologies are also installed in vehicles in such a way that the infrared light source can be integrated into all possible types of display devices, regardless of the display embodiment.

According to a further advantageous embodiment of the vehicle occupant detection device according to the invention, a grid is stored in the computing unit, wherein the grid describes a subdivision of at least one portion of the observation region into a plurality of grid elements, a mapping between grid elements and IR light elements is stored in the computing unit, and the computing unit is further configured to deactivate the IR light element mapped to the at least one grid element in which the IR reflection is located, or at least to reduce its brightness when an IR reflection is detected in a camera image.

In this way, it is particularly easy for the computing unit to determine which IR light elements are to be deactivated or have their brightness reduced in order to prevent the reflection from occurring, or at least to attenuate it to such an extent that the relevant area of the person's face to be observed can also be reliably detected.

In a further advantageous embodiment of the vehicle occupant detection device according to the invention, provision is further made for a grid to be stored in the computing unit, wherein the grid describes a subdivision of at least one portion of the observation region into a plurality of grid elements, a mapping between grid elements and IR light elements is stored in the computing unit, and the computing unit is further configured to activate the IR light element mapped to the at least one grid element in which the IR shadow is located, or to increase its brightness when an IR shadow is detected in a camera image. This makes it particularly easy not only to suppress or at least attenuate IR reflections, but also to counteract the formation of IR shadows. IR shadows can thus be brightened or even completely removed from a camera image.

The mapping between grid elements and IR light elements is fixed. The mapping can be learned, for example based on one-time calibration measurements carried out in advance. These calibration measurements can be carried out as part of the manufacture or development of the vehicle occupant detection device. This grid-based control of the matrix of IR light elements (both in connection with the avoidance of IR reflections and in connection with the avoidance of IR shadows) can be compared to an adaptive full beam assistant of a vehicle with matrix headlights. Thus in a corresponding full beam assistant, individual pixels of the matrix headlight are switched to dark-on for areas in which a traffic travelling ahead or oncoming traffic is detected. Accordingly, IR light elements are deactivated or activated in a specific manner here if IR reflections or IR shadows are detected in the space regions illuminated by the corresponding IR light elements.

In a further advantageous embodiment of the vehicle occupant detection device, provision is made that the computing unit is further configured to control the matrix of IR light elements to emit a structured light pattern and to determine a relative position of at least one body part of the person in the observation region by evaluating a distortion of the structured light pattern present in a camera image.

The vehicle occupant detection device according to the invention thus enables individual body parts of the person being observed to be located in the observation region on the basis of active triangulation. Accordingly, the structured light pattern generated by means of the infrared light source is not only projected onto the eye area of the person, but also onto other areas of the body, such as the rest of the face, or even the shoulders, arms, hands, upper body, and similar. This enables the provision of additional assistance functions.

Thus, in a further advantageous embodiment of the vehicle occupant detection device according to the invention provision is made for the computing unit to be further configured to analyze at least two consecutive camera images in order to recognize a change in the relative position of the body part and to detect from it the performance of a gesture by the person. This enables the computing unit to recognize gestures, which in turn can be interpreted as operation actions. For example, the person can raise their hand and turn it in a circle in the air, which can be interpreted as the rotation of a rotary control. Corresponding swiping movements upwards, downwards or to the side can be interpreted as the actuation of a slide control.

A vehicle according to the invention comprises at least one vehicle occupant detection device as described above. There is at least one vehicle occupant detection device for detecting the person driving the vehicle. However, further vehicle occupant detection devices can also be integrated into the vehicle in order to detect further vehicle occupants, for example the front-seat passenger.

The vehicle can be embodied, for example, as a car, lorry, van, bus or similar. It does not necessarily have to be a road vehicle. It may also be a rail vehicle, watercraft, or aircraft.

According to an advantageous embodiment of the vehicle according to the invention, the display device is formed by the display of an instrument cluster, a central display, a passenger display, or a head unit. Thus, the vehicle occupant detection device according to the invention can be integrated particularly flexibly and easily into a wide variety of vehicles. If the infrared light source, i.e., the matrix of IR light elements, is integrated into the instrument cluster, its central position in front of the driver allows them to be particularly thoroughly illuminated. When integrated into the head unit, several vehicle occupants, for example the driver, front-seat passenger and a person sitting in the center of the rear, can be illuminated simultaneously.

In a further advantageous embodiment of the vehicle provision is further made is for it to comprise at least one airbag and a control function for deploying the airbag, wherein the computing unit is configured to provide the relative position of the at least one body part as an input variable of the control function, and the control function is configured to deploy the airbag in the event of an airbag deployment signal only if at least one body part is located within a predefined space region assigned to the airbag. This prevents the airbag from being deployed accidentally or unnecessarily. The predefined space region is formed by the space region in which a corresponding body part would collide with the inflated airbag in the event of an accident. If no body part is located in this area, the airbag deployment is also obsolete.

The control function is, for example, a dedicated airbag control unit or also an airbag control program running on another control unit or a central car computer.

Further advantageous embodiments of the vehicle occupant detection device and the vehicle according to the invention also arise from the exemplary embodiments which are described in more detail below with reference to the figures.

### BRIEF DESCRIPTION OF THE DRAWING FIGURES

Here are shown:

FIG. 1 A schematic side view of a person monitored by a vehicle occupant detection device according to the invention;

FIG. 2 A schematic and simplified layer structure of an LCD display comprising a matrix of IR light elements;

FIG. 3 A schematic representation of the pixels of a display device comprising subpixels configured to emit infrared light; and

FIG. 4 A schematic representation of a portion of a camera image of a detected person with a grid and a mapping between grid elements to corresponding IR light elements.

### DETAILED DESCRIPTION

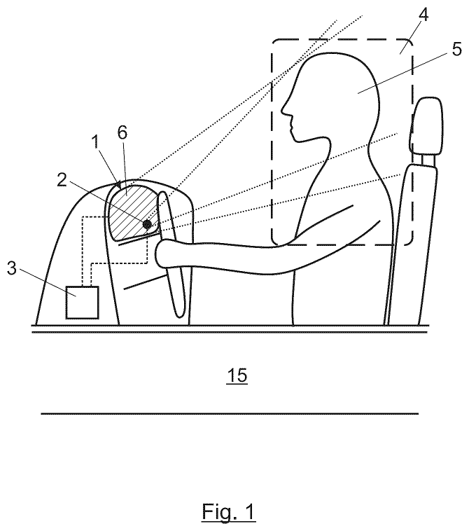

FIG. 1 shows a side view of a vehicle 15 according to the invention. There is a person 5 in the vehicle interior, in this case the driver. The person 5 is detected by a vehicle occupant detection device according to the invention. This comprises an infrared light source 1, a camera 2, and a computing unit 3. The vehicle occupant detection device tracks the line of sight of the person 5, which is used to provide driver assistance functions. For better recognition of the person 5 in adverse lighting conditions, the person 5 is illuminated with infrared light from the infrared light source 1. Accordingly, the camera 2 is configured to detect light in the infrared spectrum. Camera 2 can also have various filters for this purpose.

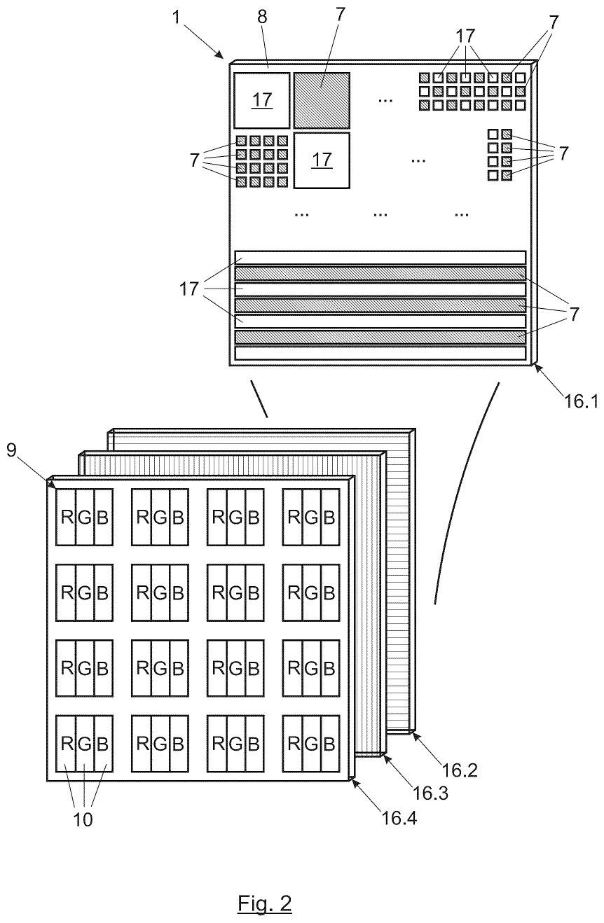

In the exemplary embodiment shown in FIG. 1, the infrared light source 1 is integrated into a display device 6, here the instrument cluster of the vehicle 15. In addition, the infrared light source 1 is formed by a matrix of IR light elements 7, which are shown in FIG. 2. The infrared light source 1 and the camera 2 are aligned with an observation region 4 in which the head of the person 5 and thus the eyes to be observed are located during use of the vehicle 15.

The camera 2 can be arranged at any location in the vehicle 15, as long as it can detect at least one face area of the person 5 in the observation region 4, preferably the eyes. For example, the camera 2 is integrated into the dashboard of the vehicle 15, in particular in the area of the display device 6, or also, as shown, integrated into the display device 6.

The vehicle occupant detection device according to the invention enables even more reliable detection of the person 5, in particular of their eyes and thus their line of sight. During operation, IR reflections 13 shown in FIG. 4 may appear in a camera image generated by the camera 2 and/or individual image areas may have an infrared shadow. The corresponding areas of the face cannot then be correctly recognized by camera 2 or the computing unit 3. This can be prevented or at least attenuated by forming the infrared light source 1 as a matrix of IR light elements 7, as shown in FIG. 2. Thus individual IR light elements 7 are activated or deactivated in a specific manner in such a way that the formation of IR reflections 13 and/or IR shadows is counteracted.

FIG. 2 shows the embodiment of the infrared light source 1 as part of the display device 6. In FIG. 2, the display device 6 is embodied as an LCD display. The display device 6 comprises, for example, four layers 16.1, 16.2, 16.3 and 16.4. The first layer 16.1 is the background lighting 8 of the display device 6. The second layer 16.2 is, for example, a thin-film transistor layer, also referred to as a thin-film transistor or TFT in abbreviated form. The third layer 16.3 is a layer of liquid crystals, i.e., the actual liquid crystals. The fourth layer 16.4 is a color filter layer or “pixel layer” comprising a plurality of pixels 9 arranged in a matrix. The display device 6 can have further components that are not defined in detail and are not shown, such as a polarizing filter, a substrate, electrodes, a cover layer, a diffuser, or scattering layer, and similar.

The structure shown is exemplary; the LCD display may have an alternative structure known from the prior art, for example in FIG. 2, the pixels 9 are shown oversized for better recognition of the subpixels 10. It is particularly preferable that each pixel 9 is mapped to an IR light element 7.

According to the invention, the individual IR light elements 7 can be formed as point light sources or also as flat light sources. FIG. 2 shows different possible embodiments in different regions of the background lighting 8 (top left, top right and bottom). The IR light elements 7 are shown shaded. The background lighting 8 further comprises conventional light elements 17, for example cold white LEDs, LED strips or similar, in order to enable visibility of the display content of the display device 6 even in adverse lighting conditions.

The pixels 9 comprise various subpixels 10. For example, each pixel 9 contains one subpixel 10 for each of the colors red, green and blue, indicated by the letters R, G and B. Other color combinations are also conceivable, such as cyan, magenta and yellow, indicated by the letters C, M and Y. In the exemplary embodiment shown in FIG. 2, at least one subpixel 10 of at least some of the pixels 9 or, in principle, all pixels 9 is permeable to infrared light in such a way that the infrared light emitted by the IR light elements 7 can penetrate the front of the display device 6 and thus be projected onto the person 5. Recesses could also be provided to allow infrared light to pass through.

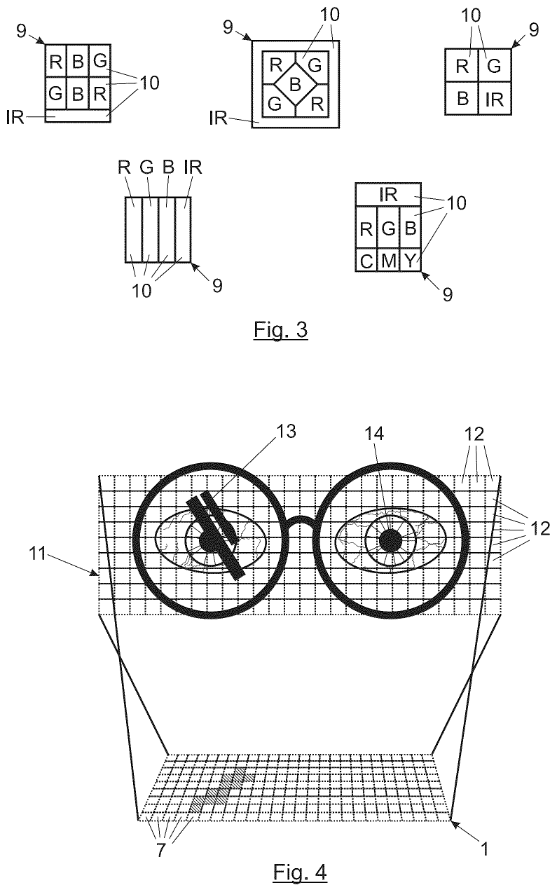

As FIG. 3 shows, it is also possible to provide a separate subpixel 10 to allow infrared light to pass through. A corresponding subpixel 10 can be identified by the letters IR.

In the exemplary embodiment shown in FIG. 3, there can also be pixels 9 of a display device 6 embodied as an OLED display. As FIG. 3 shows, all conceivable arrangement forms and geometries of the subpixels 10 are possible. The examples shown in FIG. 3 are not to be taken as limiting. Other arrangements and embodiments not shown in detail are also possible.

FIG. 4 illustrates the relationship between the areas of the face illuminated by the infrared light source 1 and the arrangement of the corresponding IR light elements 7 on or in the display device 6. FIG. 4 shows the eye area of the person 5 detected by the camera 2. A grid 11 consisting of a plurality of grid elements 12 is shown, of which only some are provided with a reference symbol for the sake of clarity. A mapping is stored in the computing unit 3 as to which of these grid elements 12 is primarily illuminated by which IR light element 7. If the computing unit 3 recognizes that IR reflections 13 are present by evaluating a corresponding camera image generated by the camera 2, the computing unit 3 determines in which grid elements 12 the IR reflection is located. The IR light elements 7 mapped to the respective grid elements 12, indicated in FIG. 4 by dark shading, are then deactivated. This causes the IR reflection 13 to disappear. The respective IR light elements 7 do not necessarily have to be deactivated, but can simply be reduced in brightness. This improves the recognition of the pupil 14 of the person 5 in such a way that the line of sight of the person 5 can be determined even more reliably by the IR camera.

In addition or alternatively, IR shadows can be avoided or at least attenuated in the corresponding manner.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A vehicle occupant detection device comprising:
an infrared light source configured to illuminate a face area of a person in an observation region of the vehicle;
a camera, wherein the infrared light source and the camera are aligned with the observation region, wherein the camera is configured to detect at least the illuminated face area; and
a computing unit configured to control the infrared light source, to evaluate at least one camera image generated by the camera, and to recognize a line of sight of the person in the at least one camera image,
wherein the infrared light source is integrated into a display device and formed by a matrix of a plurality of infrared light elements of the display device,
wherein the computing unit is further configured to
determine a selection of the plurality of infrared light elements to be activated depending on the evaluation of the at least one camera image,
activate the selection of the plurality of infrared light elements to emit infrared light,
control the matrix of the plurality of infrared light elements to emit a structured light pattern, and
determine a relative position between a pupil of the person and at least one portion of the structured light pattern in at least one subsequent camera image to determine the line of sight of the person.

11. The vehicle occupant detection device of claim 10, wherein
the display device is an LCD display, the matrix of the plurality of infrared light elements is integrated into a background lighting of the display device or forms part of the background lighting, or
the display device is an OLED display, the matrix of the plurality of infrared light elements corresponds to a matrix of pixels of the OLED display in such a way that each of the plurality of infrared light element forms an additional subpixel of a pixel of the matrix of pixels.

12. The vehicle occupant detection device of claim 10, wherein
a grid is stored in the computing unit,
the grid describes a subdivision of at least one portion of the observation region into a plurality of grid elements,
a mapping between the plurality of grid elements and the plurality of infrared light elements is stored in the computing unit, and
the computing unit is further configured to deactivate one of the plurality of infrared light elements mapped to at least one of the plurality of grid elements in which an infrared reflection is located, or to reduce brightness of the one of the plurality of infrared light elements mapped to at least one of the plurality of grid elements when the infrared reflection is detected in the at least one camera image.

13. The vehicle occupant detection device of claim 10, wherein
a grid is stored in the computing unit,
the grid describes a subdivision of at least one portion of the observation region into a plurality of grid elements,
a mapping between the plurality of grid elements and the plurality of infrared light elements is stored in the computing unit, and
the computing unit is further configured to activate one of the plurality of infrared light elements mapped to at least one of the plurality of grid elements in which an infrared shadow is located or to increase brightness of the one of the plurality of infrared light elements mapped to at least one of the plurality of grid elements when an infrared shadow is detected in the at least one camera image.

14. The vehicle occupant detection device of claim 10, wherein the computing unit is further configured to:
control the matrix of infrared light elements to emit the structured light pattern; and
determine a relative position of at least one body part of the person in the observation region by evaluating a distortion of the structured light pattern present in the at least one camera image.

15. The vehicle occupant detection device of claim 14, wherein the computing unit is further configured to analyze at least two consecutive camera images of the at least one camera image to recognize a change in the relative position of the body part and to detect performance of a gesture by the person from the analysis of the at least two consecutive camera images.

16. A vehicle comprising:
a display device; and
a vehicle occupant detection device comprising
an infrared light source configured to illuminate a face area of a person in an observation region of the vehicle;
a camera, wherein the infrared light source and the camera are aligned with the observation region, wherein the camera is configured to detect at least the illuminated face area; and
a computing unit configured to control the infrared light source, to evaluate at least one camera image generated by the camera, and to recognize a line of sight of the person in the at least one camera image,
wherein the infrared light source is integrated into the display device and formed by a matrix of a plurality of infrared light elements of the display device,
wherein the computing unit is further configured to
determine a selection of the plurality of infrared light elements to be activated depending on the evaluation of the at least one camera image,
activate the selection of the plurality of infrared light elements to emit infrared light,
control the matrix of the plurality of infrared light elements to emit a structured light pattern, and
determine a relative position between a pupil of the person and at least one portion of the structured light pattern in at least one subsequent camera image to determine the line of sight of the person.

17. The vehicle of claim 16, wherein the display device is a display of an instrument cluster, a central display, a passenger display, or a head unit of the vehicle.

18. The vehicle of claim 16, further comprising:
at least one airbag; and
a controller,
wherein the computing unit is configured to provide the relative position of the at least one body part as an input variable of the controller, and the controller is configured to deploy the airbag in the event of an airbag deployment signal only when at least one body part is located within a predefined space region assigned to the at least one airbag.

19. A method for detecting a vehicle occupant, the method comprising:
illuminating, by an infrared light source of the vehicle, a face area of a person in an observation region of the vehicle, wherein the infrared light source is a matrix of a plurality of infrared light elements;
detecting, by a camera of the vehicle, at least the illuminated face area in at least one camera image captured by the camera, wherein the infrared light source and the camera are aligned with the observation region;
evaluating the at least one camera image to determine a selection of the plurality of infrared light elements to be activated;
activating the selection of the plurality of infrared light elements to emit infrared light;
controlling the matrix of the plurality of infrared light elements to emit a structured light pattern; and
determine a relative position between a pupil of the person and at least one portion of the structured light pattern to determine a line of sight of the person in at least one subsequent camera image; and
detecting a line of sight of the person in the at least one subsequent camera image,
wherein the infrared light source is integrated into a display device of the vehicle and formed by a matrix of a plurality of infrared light elements of the display device.
